(19) United States
(12) Patent Application Publication
(10) Pub. No.: US 2020/0172677 A1
(43) Pub. Date: Jun. 4, 2020

(54) STABILIZATION OF NOBLE METAL CATALYSTS

(71) Applicant: WACKER CHEMIE AG, Munich (DE)

(72) Inventors: Andreas KOELLNBERGER, Kirchdorf (DE); Michael BAUER, Mehring (DE); Erich PILZWEGER, Julbach (DE)

(73) Assignee: WACKER CHEMIE AG, Munich (DE)

(21) Appl. No.: 16/636,385

(22) PCT Filed: Aug. 4, 2017
(86) PCT No.: PCT/EP2017/069788

§ 371 Date: Feb. 4, 2020

(51) Int. Cl. C08G 77/08; C08G 77/12; C08G 77/20; C08L 83/04; B01J 23/44

(52) U.S. Cl. CPC C08G 77/08; C08G 77/12; B01J 23/44; C08L 83/04; C08G 77/20

(57) ABSTRACT

Shelf life of noble metal catalyzed addition crosslinkable organosilicon compositions is remarkably increased by treatment of a noble metal catalyst having an oxidation state greater than 0 with a bidentate chelate compound. The latter may remain in the catalyst mixture or be removed, and the treatment may be performed in situ or ex situ with respect to the remainder of the crosslinkable composition components.

### CROSS REFERENCE TO RELATED APPLICATIONS

This application is the U.S. National Phase of PCT Appln. No. PCT/EP2017/069788 filed Aug. 4, 2017, the disclosure of which is incorporated in its entirety by reference herein.

### BACKGROUND OF THE INVENTION

### 1. Field of the Invention

The present invention relates to a novel method for stabilizing noble metal catalysts. The invention particularly relates to the field of addition-crosslinking silicone compositions that are activated by heat or by ultraviolet or visible radiation, to the production thereof, to the use thereof in crosslinkable compositions and to crosslinked products produced therefrom.

### 2. Description of the Related Art

In addition-crosslinking silicone compositions, the crosslinking process is generally effected via a hydrosilylation reaction in which typically platinum or another metal from the platinum group is used as a catalyst.

During the catalytic reaction, aliphatically unsaturated groups having Si-bonded hydrogen are reacted in order to convert the addition-crosslinkable silicone composition to the elastomeric state via forming a network.

Structurally diverse catalysts are known from the prior art. They are typically activated either by heat or by ultraviolet and/or visible radiation. Particularly reactive systems, which typically comprise Pt(0) complexes such as the so-called Karstedt catalyst, are capable of crosslinking addition-crosslinking silicones even at room temperature. Owing to their high reactivity, these catalysts are only suitable for two-component systems, in which the reactive constituents are mixed only shortly before processing. Such systems are referred to as RTV-2 systems.

The need for one-component addition-crosslinking silicone rubber systems, which ideally do not cure at all at room temperature and cure as rapidly as possible at elevated temperature or when exposed to ultraviolet and/or visible radiation, has been known for a long time. In the prior art, various approaches are known for solving the problem of premature crosslinking. One possibility consists of the use of inhibitors, which are added to the mixture as additives, in order to extend the pot life. They are always used in molar excess relative to the catalyst compound and inhibit the catalytic activity thereof. However, with increasing amount of inhibitor, besides extension of the pot life, reactivity of the system decreases at elevated temperatures and the onset temperature increases. In the literature, there are numerous examples of inhibitors from different substance classes.

U.S. Pat. No. 3,723,567 A discloses amino-functional silanes as inhibitors. Alkyldiamines in conjunction with an acetylenically unsaturated alcohol are used for inhibition in U.S. Pat. No. 5,270,422 A. EP0761759 A2 claims a combination of inhibitors, a phosphite together with a further inhibitor, such as maleates and ethynols, being used. DE19757221 A1 also describes the phosphite substance class in the use of an inhibitor. Phosphines are claimed in U.S. Pat. No. 4,329,275 A as additive for inhibition. A combination of phosphites in conjunction with organic peroxides is described in EP1437382 A1. In addition to negative effects on the crosslinking kinetics, the use of partially volatile inhibitors or inhibitors which release volatile constituents, has also proven to be unfavorable. WO2016133946A1 uses microencapsulated catalysts to achieve a long storage period. The disadvantage of this method is that unintentional input of shear energy can result in premature crosslinking of the materials.

EP0545591B1 claims a preformed platinum catalyst with platinum in the oxidation state 0, which can be achieved by the addition of ligands to the silicone mixture. This is added at least to an equimolar extent (1-60 fold) in order to achieve a pot life of 5 days at 50° C. The existence of the reaction product between the platinum catalyst and the added ligands was demonstrated in the examples by various analytical methods. The difference in this method and the use of discrete chemical compounds consists of the fact that, in the reaction of ligand and platinum compound in a silicone mixture, complete conversion cannot be guaranteed and, in addition to the desired main product, diverse by-products are formed.

Mixtures having complete inhibition at room temperature and no impact on the reaction rate under curing conditions by means of an appropriate additive are not currently known.

According to the prior art, the catalysts used are normally activated thermally, i.e. the addition-crosslinkable silicone composition must therefore be heated for the crosslinking process. In accordance with the prior art, the silicone composition in this case frequently has to be applied to a substrate, as is the case, for example, in coating processes, in selected potting, molding and co-extrusions or other molding methods. The actual vulcanization process takes place in this case by means of a heating process, for which cost- and energy-intensive plants often have to be operated.

In addition to thermal activation of catalysts, also known are those which are activated by irradiation. In the technical literature a multiplicity of platinum complexes is described which are suitable to initiate a hydrosilylation reaction by irradiation. All platinum catalysts described can be activated by light and, even after switching off the light source, are capable of crosslinking silicone compositions. This procedure is known to those skilled in the art as a dark reaction.

EP0122008 B1 describes UV-crosslinkable silicone compositions comprising a (η-diolefin) (σ-aryl)platinum complex as photosensitive catalyst. A high catalytic activity is cited as advantageous. A disadvantage, however, is that this catalyst class exhibits only modest dispersibility in the silicone matrix. Also, for light-induced decomposition of the platinum catalyst, the use of very short-wave UV-C radiation is required, which inevitably leads to high ozone pollution in the direct surroundings of a production line.

EP0561919 B1 describes a method for radiation-crosslinking hydrolsilylation in which the compositions, in addition to (η-diolefin) (σ-aryl)platinum complexes, additionally comprise a free-radical photoinitiator which absorbs actinic radiation and in this manner contributes to an increase in the light yield. This combination of (η-diolefin) (σ-aryl)platinum complex and free-radical photoinitiator enables the initiation of a hydrosilylation reaction with an accelerated crosslinking process. However, the use of an additional compound must be considered in principle as disadvantageous since this makes the production process correspondingly more complex.

In contrast, EP0398701 B1 claims Pt(II)-β-diketonate complexes, which have the advantage of a long pot life in conjunction with a short gelling time on exposure. However, the relatively polar compounds have the disadvantage of poor solubility in the silicone matrix and are therefore of only limited suitability for many applications.

EP0146307 B1 discloses (η⁵-cyclopentadienyl)tri(σ-alkyl)platinum(IV) complexes which are characterized by good solubility in the silicone matrix. Using the complexes, relatively highly concentrated solutions can also be achieved. A major disadvantage of the compounds, however, is their relatively high vapor pressure and their volatility. As a result, it cannot be excluded that the platinum concentration changes when a vacuum is applied in the production or processing of the silicone elastomer. A further consequence thereof not to be excluded is the contamination of the ambient air with platinum compounds of toxicological concern.

In EP0358452 B1 sensitizers are added to the compositions comprising (η⁵-cyclopentadienyl)tri(σ-alkyl)platinum(IV) complexes as catalyst, in order to shift to longer wavelengths the irradiated light required for crosslinking. The advantage resulting therefrom is that the mixtures can be hardened with visible light instead of with ultraviolet light.

EP0561893 B1 describes radiation-crosslinkable compositions which, in addition to (η⁵-cyclopentadienyl)tri(σ-alkyl)platinum(IV) complexes, additionally comprise a free-radical photoinitiator which absorbs actinic radiation and in this manner contributes to an increase in the light yield. This combination enables an increase in the quantum yield of the mixtures used. The increased in dark reactivity which results must be considered as a disadvantage. In addition, both the production process costs and material costs are raised by the use of an additional compound.

EP1803728 A1 discloses modified (η⁵-cyclopentadienyl)tri(σ-alkyl)platinum(IV) complexes bearing specific substituents (naphthyl, anthracenyl, etc.) on the cyclopentadienyl ring in order to increase the quantum yield and to shift the light wavelength required for activation to longer wavelengths. The linking of aromatic rings, however, has an adverse effect on the solubility of the complexes in the silicone matrix. These compounds also have the disadvantage of volatility.

Discrete chemical compounds which are already stabilized in the synthesis by the choice of ligands on the central atom are complexes which, for example, comprise G-alkyl noble metal compounds such as in EP0994159B1, EP0146307B1 or in WO2009092762, in which the central atom can be allocated oxidation states +II and +IV.

### SUMMARY OF THE INVENTION

An object of the present invention was therefore to provide silicone compositions more stable at room temperature, particularly one-component silicone compositions, which do not exhibit the disadvantage of a reduced reaction or crosslinking rate such as in the case of the use of inhibitors or platinum compounds formed in-situ. In addition, these compositions, after thermal- or radiation-induced activation, should also enable rapid polymerization. Surprisingly, this object could be achieved by the silicone compositions according to the invention, wherein a platinum hydrosilylation catalyst containing platinum in an oxidation state greater than 0 is treated with a bidentate chelating ligand. Treatment preferably occurs prior to mixing the catalyst into the crosslinkable ingredients, and the bidentate chelating ligand is preferably removed prior to mixing.

### DETAILED DESCRIPTION OF THE PREFERRED EMBODIMENTS

A first embodiment of the subject matter of this application is directed to addition-crosslinking silicone compositions selected from the group comprising
in each case at least one compound (A), (B), (D) and (E),
in each case at least one compound (C), (D), and (E),
   and/or
in each case at least one compound (A), (B), (C), (D) and (E)
wherein
   (A) is an organic compound or an organosilicon compound comprising at least two radicals having aliphatic carbon-carbon multiple bonds,
   (B) is an organosilicon compound comprising at least two Si-bonded hydrogen atoms,
   (C) is an organosilicon compound comprising SiC-bonded radicals having aliphatic carbon-carbon multiple bonds and Si-bonded hydrogen atoms,
   (D) is a noble metal catalyst, wherein the noble metal is in an oxidation state greater than 0, and
   (E) is an at least bidentate chelate ligand,
      with the proviso that the compound (D) and (E) have been pre-mixed, or the compound (E) is mixed into the composition uniformly with compound (D), and with the proviso that the compound (E) remains in the silicone composition.

A second embodiment of the subject matter of this invention is directed to addition-crosslinking silicone compositions selected from the group comprising
in each case at least one compound (A), (B), (D) and (E),
in each case at least one compound (C), (D) and (E),
   and/or
in each case at least one compound (A), (B), (C), (D) and (E)
wherein
   (A) is an organic compound or an organosilicon compound comprising at least two radicals having aliphatic carbon-carbon multiple bonds,
   (B) is an organosilicon compound comprising at least two Si-bonded hydrogen atoms,
   (C) is an organosilicon compound comprising SiC-bonded radicals having aliphatic carbon-carbon multiple bonds and Si-bonded hydrogen atoms,
   (D) is a noble metal catalyst, wherein the noble metal is in an oxidation state of greater than 0, and
   (E) is an at least bidentate chelate ligand,
      with the proviso that the compound (D) and (E) have been pre-mixed, and
      with the proviso that the compound (E), after treatment and prior to mixing with the other components, has been removed.

In the production of these compositions according to the invention, potent multidentate ligands (E) are added either a) during the catalyst preparation or b) during the formulation of the inventive, preferably one-component, silicone compositions. The mode of action of these ligands does not correspond in this case to that of an inhibitor as known in the prior art, but to that of a “scavenger”, i.e. a type of capture. The chemical bonding of the scavenger-ligand with certain catalyst species is so strong at room temperature that the compound is no longer capable of catalyzing the crosslinking reaction of silicones. It is shown, surprisingly, that in the compositions according to the invention the scavenger (E) probably does not react with the catalyst (D) used for the platinum-catalyzed hydrosilylation, but selectively only with the by-products or degradation products thereof, which either are not (cannot be) removed during the catalyst synthesis or form in the course of storage by slow degradation of the catalyst (D). In the normal case, it is therefore sufficient to use this scavenger (E), with respect to the functional groups, in a substoichiometric amount, based on the noble metal (D). The noble metal catalysts (D) used in this case have an intrinsic thermal stability such that the degradation or decomposition takes place very slowly, or not at all, at room temperature. Only at elevated temperature and/or by irradiation with visible or ultraviolet radiation is the major part of the noble metal catalysts (D) activated and the hydrosilylation can then proceed. Preferred as (E) are those scavengers which do not substantially influence the reaction rate.

In the context of the present invention, organopolysiloxanes are understood to mean both polymers and oligomers, for example, also including dimeric siloxanes.

The compounds (A), and (B) or (C) used in the silicone compositions according to the invention are selected, as is known, so that crosslinking is possible. For instance, compound (A) by way of example has at least two aliphatically unsaturated radicals and (B) at least three Si-bonded hydrogen atoms, or compound (A) has at least three aliphatically unsaturated radicals and siloxane (B) at least two Si-bonded hydrogen atoms or, instead of compound (A) and (B), siloxane (C) is used having aliphatically unsaturated radicals and Si-bonded hydrogen atoms in the ratios specified above. Also possible are mixtures of (A) and (B) and (C), having the ratios specified above of aliphatically unsaturated radicals and Si-bonded hydrogen atoms.

Compound (A)

The compounds (A) used in accordance with the invention can be silicon-free organic compounds preferably having at least two aliphatically unsaturated groups, and also organosilicon compounds preferably having at least two aliphatically unsaturated groups, and also can be mixtures thereof.

Examples of silicon-free organic compounds (A) are 1,3,5-trivinylcyclohexane, 2,3-dimethyl-1,3-butadiene, 7-methyl-3-methylene-1,6-octadiene, 2-methyl-1,3-butadiene, 1,5-hexadiene, 1,7-octadiene, 4,7-methylene-4,7,8,9-tetrahydroindene, methylcyclopentadiene, 5-vinyl-2-norbornene, bicyclo[2.2.1]hepta-2,5-diene, 1,3-diisopropenylbenzene, vinyl group-containing polybutadiene, 1,4-divinylcyclohexane, 1,3,5-triallylbenzene, 1,3,5-trivinylbenzene, 1,2,4-trivinylcyclohexane, 1,3,5-triisopropenylbenzene, 1,4-divinylbenzene, 3-methylheptadiene-(1,5), 3-phenylhexadiene-(1,5), 3-vinylhexadiene-1,5 and 4,5-dimethyl-4,5-diethyloctadiene-(1,7), N,N′-methylenebisacrylamide, 1,1,1-tris(hydroxymethyl)propane triacrylate, 1,1,1-tris(hydroxymethyl)propane trimethacrylate, tripropylene glycol diacrylate, diallyl ether, diallylamine, diallyl carbonate, N,N′-diallylurea, triallylamine, tris(2-methylallyl)amine, 2,4,6-triallyloxy-1,3,5-triazine, triallyl-s-triazine-2,4,6(1H,3H,5H)-trione, diallyl malonate, polyethylene glycol diacrylate, polyethylene glycol dimethacrylate, and poly(propylene glycol) methacrylate.

The silicone compositions according to the invention preferably comprise as constituent (A) at least one aliphatically unsaturated organosilicon compound, wherein all aliphatically unsaturated organosilicon compounds useful in addition-crosslinking compositions can be used, such as silicone block copolymers having urea segments, silicone block copolymers having amide segments and/or imide segments and/or ester-amide segments and/or polystyrene segments and/or silarylene segments and/or carborane segments and silicone graft copolymers having ether groups.

The organosilicon compounds (A) comprising SiC-bonded radicals having aliphatic carbon-carbon multiple bonds are preferably linear or branched organopolysiloxanes composed of units of the general formula (I)

RₐR⁴_{b}SiO_{(4-a-b)/2} (I)

where
R is each independently an organic or inorganic radical free of aliphatic carbon-carbon multiple bonds,
R⁴ is each independently a monovalent substituted or unsubstituted SiC-bonded hydrocarbon radical having at least one aliphatic carbon-carbon multiple bond,
a is 0, 1, 2 or 3, and
b is 0, 1 or 2,
   with the proviso that the sum of a+b is less than or equal to 3 and at least 2 radicals R⁴ are present per molecule.

The radical R can be monovalent or multivalent radicals, wherein multivalent radicals such as bivalent, trivalent and tetravalent radicals, then bond two or more, such as two, three or four siloxy units of the formula (I) to one another.

Further examples of R are the monovalent radicals —F, —Cl, —Br, OR⁵, —CN, —SCN, —NCO and SiC-bonded substituted or unsubstituted hydrocarbon radicals which may be interrupted by oxygen atoms or the group —C(O)—, and also bivalent radicals Si—C bonded on both sides according to formula (I). If the radicals R are SiC-bonded substituted hydrocarbon radicals, preferred substituents are halogen atoms, phosphorus-containing radicals, cyano radicals, —OR⁵, —NR⁵—, —NR⁵₂, —NR⁵—C(O)—NR⁵₂, —C(O)—NR⁵₂, —C(O)R⁵, —C(O) OR⁵, —SO₂-Ph and —C₆F₅. In this case, R⁵ is each independently a hydrogen atom or a monovalent hydrocarbon radical having 1 to 20 carbon atoms, and Ph is a phenyl radical.

Examples of radicals R are alkyl radicals such as the methyl, ethyl, n-propyl, isopropyl, n-butyl, isobutyl, tert-butyl, n-pentyl, isopentyl, neopentyl, and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical, and octadecyl radicals such as the n-octadecyl radical, cycloalkyl radicals such as cyclopentyl, cyclohexyl, cycloheptyl and methylcyclohexyl radicals, aryl radicals such as the phenyl, naphthyl, anthryl and phenanthryl radicals, alkaryl radicals such as o-, m-, p-tolyl radicals, xylyl radicals and ethylphenyl radicals, and aralkyl radicals such as the benzyl radical, and the α- and the β-phenylethyl radicals.

Examples of substituted radicals R are haloalkyl radicals such as the 3,3,3-trifluoro-n-propyl radical, the 2,2,2,2′,2′2′-hexafluoroisopropyl radical, the heptafluoroisopropyl radical, haloaryl radicals such as the o-, m- and p-chlorophenyl radicals, —(CH₂)—N(R⁵)C(O)NR⁵₂, —(CH₂)ₙ—C(O)NR⁵₂, —(CH₂)ₙ—C(O) R⁵, —(CH₂)ₙ—C(O)OR⁵, —(CH₂)ₙ—C(O)NR⁵₂, —(CH₂)—C(O)—(CH₂)ₘC(O)CH₃, —(CH₂)—O—CO—R⁵, —(CH₂)—NR⁵—(CH₂)ₘ—NR⁵₂, —(CH₂)ₙ—O—(CH₂)ₘCH(OH)CH₂OH, —(CH₂)ₙ(OCH₂CH₂)ₘOR⁵, —(CH₂)ₙ—SO₂-Ph and —(CH₂)ₙ—O—C₆F₅, where R⁵ and Ph correspond to the definitions specified above and n and m are identical or different integers between 0 and 10.

Examples of R which are bivalent radicals, Si-bonded on both sides according to formula (I), are those which derive from the monovalent examples mentioned above for radical R effected by an additional bond by substitution of a hydrogen atom. Examples of such radicals are —(CH₂)—, —CH(CH₃)—, —C(CH₃)₂—, —CH(CH₃)—CH₂—, —C₆H₄—, —CH(Ph)-CH₂—, —C(CF₃)₂—, —(CH₂)—CH₄—(CH₂)ₙ—, —(CH₂)ₙ—C₆H₄—C₆H₄—(CH₂)ₙ—, —(CH₂O)ₘ, (CH₂CH₂O)ₘ, —(CH₂)ₙ—Oₓ—C₆H₄—SO₂—C₆H₄—Oₓ—(CH₂)ₙ—, where x is 0 or 1, and Ph, m and n have the definitions specified above.

The radical R is preferably a monovalent SiC-bonded, optionally substituted hydrocarbon radical having 1 to 18 carbon atoms free of aliphatic carbon-carbon multiple bonds, more preferably a monovalent SiC-bonded hydrocarbon radical having 1 to 6 carbon atoms free of aliphatic carbon-carbon multiple bonds, and especially the methyl or phenyl radical.

The radical R⁴ can be any groups amenable to an addition reaction (hydrosilylation) with an SiH-functional compound.

If the radical R⁴ are SiC-bonded substituted hydrocarbon radicals, preferred as substituents are halogen atoms, cyano radicals and —OR⁵, where R⁵ has the aforementioned definition.

The radicals R⁴ are preferably alkenyl or alkynyl groups having 2 to 16 carbon atoms such as vinyl, allyl, methallyl, 1-propenyl, 5-hexenyl, ethynyl, butadienyl, hexadienyl, cyclopentenyl, cyclopentadienyl, cyclohexenyl, vinylcyclohexylethyl, divinylcyclohexylethyl, norbornenyl, vinylphenyl and styryl radicals, wherein particular preference is given to using vinyl, allyl and hexenyl radicals.

The molecular weight of constituent (A) can vary within broad limits, between approximately 10² and 10⁶ g/mol. For instance, the constituent (A) can be, for example, a relatively low molecular weight alkenyl-functional oligosiloxane such as 1,2-divinyltetramethyldisiloxane, but may also be a high-polymer polydimethylsiloxane, for example with a molecular weight of 10⁵ g/mol (number average determined by means of NMR), that possesses pendant or terminal Si-bonded vinyl groups. The structure of the molecules forming the constituent (A) is also not fixed; in particular, the structure of a siloxane of relatively high molecular mass, in other words an oligomeric or polymeric siloxane, may be linear, cyclic, branched, or else resinous, network-like. Linear and cyclic polysiloxanes are preferably composed of units of the formula R₃SiO_{1/2}, R⁴R₂SiO_{1/2}, R⁴RSiO_{1/2} and R₂SiO_{2/2}, where R and R⁴ have the definitions specified above. Branched and network-like polysiloxanes additionally comprise trifunctional and/or tetrafunctional units, with preference being given to those of the formulae RSiO_{3/2}, R⁴SiO_{3/2} and SiO_{4/2}. It will be appreciated that mixtures of different siloxanes satisfying the criteria of constituent (A) may also be used.

Particularly preferred as compound (A) are vinyl-functional, substantially linear polydiorganosiloxanes having a viscosity of 0.01 to 500 000 Pa·s, more preferably 0.1 to 100,000 Pa·s, in each case at 25° C. and a shear rate of 1 sec-1.

The viscosities in the present text are determined in accordance with DIN EN ISO 3219: 1994 (polymers/resins in the liquid, emulsified or dispersed state) and DIN 53019. The measurement of viscosities and flow curves at 25° C. can be determined, for example, with rotary viscometers such as a rotary rheometer with air mounting from Anton Paar MCR301 with plate/cone systems or comparable instruments.

Compound (B)

As organosilicon compound (B) it is possible to use all hydrogen-functional organosilicon compounds which are useful in addition-crosslinkable compositions.

Organopolysiloxanes (B) which comprise Si-bonded hydrogen atoms are preferably linear, cyclic, or branched organopolysiloxanes composed of units of the general formula (II)

R_{c}H_{d}SiO_{(4-c-d)/2} (II)

where
R has the definition specified above,
c is 0, 1, 2 or 3 and
d is 0, 1 or 2,
   with the proviso that the sum of c+d is less than or equal to 3 and there are at least two Si-bonded hydrogen atoms per molecule.

The organopolysiloxane (B) used in accordance with the invention preferably comprises Si-bonded hydrogen in the range from 0.04 to 1.7 percent by weight, based on the total weight of the organopolysiloxane (B).

The molecular weight of the constituent (B) may likewise vary within wide limits, as for instance between 10² and 10⁶ g/mol. Thus constituent (B) may be, for example, an SiH-functional oligosiloxane of relatively low molecular mass, such as tetramethyldisiloxane, but also a high-polymer polydimethylsiloxane that possesses SiH groups within the chain or terminally or a silicone resin having SiH groups.

The structure of the molecules that form the constituent (B) is also not fixed; in particular, the structure of an SiH-containing siloxane of relatively high molecular mass, in other words oligomeric or polymeric, may be linear, cyclic, branched, or else resinous, network-like. Linear and cyclic polysiloxanes (B) are composed preferably of units of the formula R₃SiO_{1/2}, HR₂SiO_{1/2}, HRSiO_{2/2} und R₂SiO_{2/2}, where R has the definition stated above. Branched and network-like polysiloxanes additionally include trifunctional and/or tetrafunctional units, with preference being given to those of the formulae RSiO_{3/2}, HSiO_{3/2} und SiO_{4/2}, where R has the definition stated above.

It will be appreciated that mixtures of different siloxanes satisfying the criteria of constituent (B) may also be used.

Particularly preferred is the use of low molecular mass, SiH-functional compounds such as tetrakis(dimethylsiloxy)silane and tetramethylcyclotetrasiloxane, and also of SiH-containing siloxanes of higher molecular mass, such as poly(hydrogenmethyl)siloxane and poly(dimethylhydrogenmethyl)-siloxane with a viscosity at 25° C. of 10 to 10,000 mPa·s and a shear rate of 1 sec⁻¹, or analogous SiH-containing compounds in which some of the methyl groups have been replaced by 3,3,3-trifluoropropyl or phenyl groups.

The amount of constituent (B) in the crosslinkable silicone compositions according to the invention is preferably such that the molar ratio of SiH groups to aliphatically unsaturated groups from (A) is 0.1 to 20, more preferably between 1.0 and 5.0.

The compounds (A) and (B) used in accordance with the invention are commercial products or may be prepared by methods that are common in chemistry.

Instead of compounds (A) and (B), the silicone compositions according to the invention may comprise organopolysiloxanes (C), simultaneously having aliphatic carbon-carbon multiple bonds and Si-bonded hydrogen atoms. The silicone compositions according to the invention may also comprise all three compounds (A), (B), and (C).

Compound (C)

If siloxanes (C) are used, those concerned are preferably composed of units of the general formulae (III), (IV) and (V)

R_{f}SiO_{4/2} (III)

R_{g}R⁴SiO_{3-g/2} (IV)

RₕHSiO_{3-h/2} (V)

where
R and R⁴ have the definition specified above
f is 0, 1, 2 or 3,
g is 0, 1 or 2 and
h is 0, 1 or 2,
   with the proviso that per molecule there are at least 2 radicals R⁴ and at least 2 Si-bonded hydrogen atoms.

Examples of organopolysiloxanes (C) are those composed of SO_{4/2}, R₃SiO_{1/2}, R₂R⁴SiO_{1/2} and R₂HSiO_{1/2} units, known as MP resins, wherein these resins may additionally comprise RSiO_{3/2} and R₂SiO units, and also linear organopolysiloxanes substantially consisting of R₂R⁴SiO_{1/2}, R₂SiO and RHSiO units with R and R⁴ meeting the aforementioned definition.

The organopolysiloxanes (C) preferably have an average viscosity of 0.01 to 500,000 Pa·s, more preferably 0.1 to 100,000 Pa·s, in each case at 25° C. and a shear rate of 1 sec-1. Organopolysiloxanes (C) are preparable by methods that are common in chemistry.

Compound (D)

Compounds (D) are noble metal catalysts, where the noble metal is in an oxidation state of greater than 0. This is necessary since, surprisingly, it has been found that only then does compound (E) act as a scavenger and capture catalytically active by-products and degradation products, thereby blocking the catalytic effect thereof and thus enabling very long pot lives of the silicone compositions according to the invention.

The noble metal catalysts (D) of the platinum group such as Pt and Pd are Pt and Pd preferably in the +II and +IV oxidation states. In the case of noble metal catalysts (D) of the iridium group such as Ir and Rh, Ir and Rh are preferably in the +I and +III oxidation states.

Examples of suitable platinum compounds as compound (D) are: Pt(II) β-diketonate complexes, (η-diolefin) (σ-aryl)platinum complexes, (η-diolefin) (σ-alkyl)platinum complexes (η5-cyclopentadienyl)tri(σ-alkyl)platinum(IV) complexes, bis(acetylacetonato)Pt(II) complexes, bis(phosphine)platinum(II) dihalide complexes, bis(σ-alkynyl) (1,5-cyclooctadiene)platinum(II) complexes. The pendant groups of the complexes specified above can vary within wide limits. The essential feature is only the direct environment of the central metal.

Specific suitable examples of compound (D) are: bis(acetylacetonato)Pt(II), bis(σ-tert-butylethynyl)cyclooctadiene Pt(II), bis(σ-tert-butylphenyl)cyclooctadiene Pt(II), bis(σ-1-ethynyl-1-cyclohexanol)cyclooctadiene Pt(II), trimethyl[(allyldimethylsilyl)cyclopentadienyl]platinum(IV), trimethyl[((2-methylallyl)dimethylsilyl)cyclopentadienyl]platinum(IV), trimethyl[(trimethoxysilyl)methyl(allyldimethylsilyl)cyclopentadienyl]platinum(IV), trimethyl[(2-trimethoxysilyl)ethyl (allyldimethylsilyl)cyclo pentadienyl]platinum(IV), trimethyl[(3-trimethoxysilyl)propyl(allyldimethylsilyl)cyclopentadienyl]platinum(IV), trimethyl[(3-dimethoxymethylsilyl)propyl (allyldimethylsilyl) cyclopentadienyl]platinum(IV), trimethyl[(4-trimethoxysilyl)butyl(allyldimethylsilyl)cyclopentadienyl]platinum(IV), trimethyl[(2-trimethoxysilyl)-1-methylethyl (allyldimethylsilyl)cyclopentadienyl]platinum(IV), trimethyl[(3-trimethoxysilyl)-2-methyl-2-propyl(allyldimethylsilyl)cyclopentadienyl]platinum(IV), trimethyl[bis(allyldimethylsilyl)cyclopentadienyl]platinum(IV), trimethyl[bis(2-methylallyldimethylsilyl)cyclopentadienyl]platinum(IV), trimethyl[(3-dimethoxymethylsilyl)propyl(tert-butyl) cyclopentadienyl]platinum(IV), trimethyl[(trimethoxysilyl)methylbis(allyldimethylsilyl)cyclopentadienyl]platinum(IV), trimethyl[(2-trimethoxysilyl)ethylbis(allyldimethylsilyl) cyclopentadienyl]platinum(IV), trimethyl[(3-trimethoxysilyl)propylbis(allyldimethylsilyl) cyclopentadienyl]platinum(IV), trimethyl[(4-trimethoxysilyl)butylbis(allyldimethylsilyl) cyclopentadienyl]platinum(IV), trimethyl[(2-trimethoxysilyl)-1-methylethylbis(allyldimethylsilyl) cyclopentadienyl]platinum(IV), trimethyl[(3-trimethoxysilyl)-2-methyl-2-propylbis(allyldimethylsilyl)cyclopentadienyl]platinum(IV), trimethyl[tris(allyldimethylsilyl)cyclopentadienyl]platinum(IV), trimethyl[(triethoxysilyl)methyl(allyldimethylsilyl)cyclopentadienyl]platinum(IV), trimethyl[(triacetoxysilyl)methyl(allyldimethylsilyl)cyclopentadienyl]platinum(IV), trimethyl[(3-bis-trimethylsiloxy)methylsilylpropyl] (allyldimethylsilyl) cyclopentadienyl platinum(IV), trimethyl[(3-triethoxysilyl)propyl(allyldimethylsilyl)cyclopentadienyl]platinum(IV), trimethyl[(triethoxysilyl)methylbis(allyldimethylsilyl)cyclopentadienyl]platinum(IV), trimethyl[(3-triethoxysilyl)propylbis(allyldimethylsilyl) cyclopentadienyl]platinum(IV), trimethyl[(triethoxysilyl)methyltris(allyldimethylsilyl)cyclopentadienyl]platinum(IV), triethyl[(allyldimethylsilyl)cyclopentadienyl]platinum(IV), tris(trimethylsilylmethyl)[(allyldimethylsilyl)cyclopentadienyl]platinum(IV), triethyl[(trimethoxysilyl)methyl(allyldimethylsilyl)cyclopentadienyl]platinum(IV), triethyl[(trimethoxysilyl)methylbis(allyldimethylsilyl)cyclopentadienyl]platinum(IV), triethyl[tris(allyldimethylsilyl)cyclopentadienyl]platinum(IV) and triethyl[(trimethoxysilyl)methyltris(allyldimethylsilyl)cyclopentadienyl]platinum(IV).

The compound (D) according to the invention is preferably trimethyl[(allyldimethylsilyl)cyclopentadienyl]platinum(IV), trimethyl[bis(allyldimethylsilyl)cyclopentadienyl]platinum(IV), trimethyl[(3-dimethoxymethylsilyl)propyl(allyldimethylsilyl) cyclopentadienyl]platinum(IV), trimethyl[(3-trimethoxysilyl)propylbis(allyldimethylsilyl) cyclopentadienyl]platinum(IV) and trimethyl[(3-trimethoxysilyl)propyl(allyldimethylsilyl)cyclopentadienyl]platinum(IV), trimethyl[(3-dimethoxymethylsilyl)propyl)cyclopentadienyl]platinum(IV), (1R,2R)-cyclohexanediamine(1,2-ethanedionato)platinum(II).

The compound (D) according to the invention is more preferably trimethyl[(allyldimethylsilyl)cyclopentadienyl]platinum(IV), trimethyl[(3-dimethoxymethylsilyl)propyl (allyldimethylsilyl) cyclopentadienyl]platinum(IV) and trimethyl[(3-trimethoxysilyl)propyl(allyldimethylsilyl)cyclopentadienyl]platinum(IV), trimethyl[(allyldimethylsilyl) cyclopentadienyl]platinum(IV), trimethyl[(3-dimethoxymethylsilyl)propyl)cyclopentadienyl]platinum(IV) and reaction products thereof with OH-terminated polydialkylsiloxanolates (polymer-bound variants), in which the methoxy groups have been fully or partially replaced by OH-terminated polydimethylsiloxanes having chain lengths between 10 and 1000, bis(σ-ethynylbenzene)Pt(II) cyclooctadienes, bis(σ-tert-butylphenyl)Pt(II) cyclooctadiens.

Compound (E)

Of critical importance for the pot life of the silicone compositions according to the invention is compound (E). It is a single or a mixture of different at least bidentate ligands which are capable of binding to noble metals such as Pt, Pd, Ir and Rh having an oxidation state greater than 0.

Compound (E) is an organic compound comprising at least two heteroatoms which can bind to noble metal. Various compound classes comprising nitrogen, sulfur, oxygen or phosphorus atoms are known from the prior art which bind as strong ligands to noble metal in all oxidation states.

Examples of compound (E) are azodicarboxylates, triazolinediones, heteroaromatic nitrogen compounds, diphos ligands or Pincer ligands. In this case, whether the substances are as a molecule, or are bound to a support such as silica or a polymer, plays no role with regard to the effect.

In one embodiment of the present invention, a type of pre-treatment of the compound (D) with the compound (E) is carried out, wherein the compound (E), after the treatment and prior to mixing with the other compounds, is removed from the silicone composition according to the invention. One possibility for this pre-treatment consists of mixing compounds (E), which have been bound to a support such as silica or polymers, with (D) and subsequently to remove it by filtration.

Examples of sulfur-containing compounds (E) are: dimercaprol, dimercaptosuccinic acid, dimercaptopropanesulfonic acid or tiopronine.

Examples of oxygen-containing compound (E) are: catechol, acetylacetonate or tartaric acid.

Examples of phosphorus-containing compound(E) are: bis(diphenylphosphino)methane, BINAP, 1,2-bis(diphenylphosphino)ethane, 1,3-bis(diphenylphosphino)propane, chiraphos or DIPAMP.

Examples of compound (E) with nitrogen-containing, in part with heteroaromatic structures which may be additionally substituted are: porphyrins, 4-hydroxypyridine-2,6-dicarboxylic acid, 2,2′-bipyridine, 1,10-phenanthroline, neocuproine, biquinolines, terpyridines, bipyrazine, phthalazines, quinolin-2-ylmethanethiol, 4,4′-dipyridine, 3,3′-dipyridine, 2,4′-dipyridine, indazole, dipyridyl ketone, poly-4-vinylpyridine, poly-2-vinylpyridine, 2,2′:6′,2″-Terpyridines or 4,4′-trimethylenedipyridine, diethyl azodicarboxylate, diisopropyl azodicarboxylate or 4-phenyl-1,2,4-triazoline-3,5-dione. In this case, the hydrogen atoms of the compounds specified can be replaced by alkyl, aryl, arylalkyl, or heteroatoms.

Preference is given to dimercaprol, porphyrins, 2,2′-bipyridine, phenanthroline and neocuproine.

Particular preference is given to 2,2′-bipyridine, phenanthroline and neocuproine.

In this case, the compounds (E) as monomer may be substituted or bound to polymer structures.

Compound (E) can be mixed in at any time point. Without limiting the scope of the invention, and as already described further above in the case of compound (D), the theory of the mode of action is a reaction of the compound (E) with impurities of the compound (D). That is to say, catalyst compounds which arise as impurities from the synthesis of the catalysts (D), and also degradation products of (D) which are formed during storage. By means of this capture reaction, catalyst species are bound which otherwise result in a premature undesired crosslinking of the silicone composition. According to this theory, the compound (D) does not itself react here with compound (E). Ideally, the addition of compound (E) also does not influence, or only minimally influence, the crosslinking behavior. In the context of the invention, prolongation of the crosslinking duration up to an extent of 50% crosslinking in the case of thermal or photochemical activation of the catalyst (D) by a maximum of 50% is acceptable and therefore in accordance with the invention. The pot life of the reactive mixture is increased in turn such that inventive one-component compositions, on storage for at least 7 days at 50° C. and storage for 160 days at room temperature (at ca. 20-25° C.), exhibit a maximum increase of the dynamic viscosity at a shear rate of 10 s⁻¹ of a factor of 2.

The compound (E) is typically used in deficit to the compound (D). The molar ratio of the compound (E) to the compound (D) is in this case between 0.0001 and 10, preferably between 0.001 and 1 and more preferably between 0.005 and 0.8.

Further Optional Compounds (F) and (G)

In addition to the compounds (A), (B), (C), (D) and (E) mentioned above, further compounds (F) or (G) may be present in the silicone compositions according to the invention.

Compounds (F), for example, inhibitors and stabilizers, serve the targeted adjustment of the processing time, start-up temperature and crosslinking rate of the silicone compositions according to the invention. These inhibitors and stabilizers are very well known in the field of addition-crosslinking compositions. Examples of common inhibitors are acetylenic alcohols such as 1-ethynyl-1-cyclohexanol, 2-methyl-3-butyn-2-ol and 3,5-dimethyl-1-hexyn-3-ol, 3-methyl-1-dodecyn-3-ol, polymethylvinylcyclosiloxanes such as 1,3,5,7-tetravinyltetramethyltetracyclosiloxane, low molecular mass silicone oils having methylvinyl-SiO_{1/2} groups and/or R₂vinylSiO_{1/2} end groups, where R has the definition stated above, such as divinyltetramethydisiloxane, tetravinyldimethyldisiloxane, trialkyl cyanurates, alkyl maleates such as diallyl maleate, dimethyl maleate and diethyl maleate, alkyl fumarates such as diallyl fumarate and diethyl fumarate, organic hydroperoxides such as cumene hydroperoxide, tert-butyl hydroperoxide and pinane hydroperoxide, organic peroxides, organic sulfoxides, organic amines, diamines and amides, phosphanes and phosphites, nitriles, triazoles, diaziridines and oximes. The effect of these inhibitor additives (F) depends on their chemical structure such that the concentration must be individually determined. Inhibitors and inhibitor mixtures are preferably added in a proportion by amount of less than 1%, based on the total amount added to the mixture, preferably less than 0.1% and more preferably less than 0.01%.

Compounds (G) are all other additives which are useful for the production of addition-crosslinking compositions.

The silicone composition according to the invention may optionally comprise further additives as constituent (G) at a proportion of up to 70% by weight, preferably 0.0001 to 40% by weight. These additives can be, for example, inactive fillers, resin-like polyorganosiloxanes which are different from the siloxanes (A), (B) and (C), reinforcing and non-reinforcing fillers, fungicides, fragrances, rheological additives, corrosion inhibitors, oxidation inhibitors, photoprotective agents, flame retardants and agents for influencing the electrical properties, dispersants, solvents, adhesion promoters, pigments, dyes, plasticizers, organic polymers, heat stabilizers which are different from (F) and so on. These additives include quartz flour, diatomaceous earth, clays, chalk, lithopone, carbon black, graphite, metal oxides, metal carbonates, metal sulfates, metal salts of carboxylic acids, metal dusts, fibers such as glass fibers, plastic fibers, plastic powders, metal dusts, dyes, pigments and so on.

Examples of reinforcing fillers which can be used as compound (G) in the silicone compositions according to the invention are fumed or precipitated silicas having BET surface areas of at least 50 m²/g and also carbon blacks and activated carbons such as furnace carbon black and acetylene carbon black, preference being given to fumed and precipitated silicas having BET surface areas of at least 50 m²/g. The silica fillers mentioned can have hydrophilic character or can be hydrophobized by known methods. When mixing in hydrophilic fillers, the addition of a hydrophobizing agent is required. The content of active reinforcing filler (G) in the crosslinkable composition according to the invention is in the range of 0 to 70% by weight, preferably 0 to 50% by weight.

The silicone compositions according to the invention may, if required, be dissolved, dispersed, suspended or emulsified in liquids. The compositions according to the invention—particularly depending on the viscosity of the constituents and filler content—may be of low viscosity and pourable, have a pasty consistency, may be pulverulent or may even be smooth highly viscous masses, which may be the case in compositions often referred to and well-known in expert circles as RTV-1, RTV-2, LSR and HTV. In particular, the compositions according to the invention, if they are highly viscous, can be prepared in the form of granules. In this case, the individual granule particles can comprise all compounds, or the compounds used according to the invention are separately incorporated in different granule particles. With respect to the elastomeric properties of the crosslinked silicone compositions according to the invention, the whole spectrum is also included, beginning at extremely soft silicone gels, through gum-like materials up to highly crosslinked silicones having glass-like characteristics.

The silicone compositions according to the invention can be one-component silicone compositions as well as two-component silicone compositions.

The silicone compositions according to the invention can be produced by known methods, such as by uniform mixing of the individual compounds to give a one-component composition (1K). The sequence in this case is arbitrary but is preferably the uniform mixing of the platinum catalyst (D) with a mixture of (A), (B) optionally (F) and (G). The platinum catalyst (D) used in accordance with the invention can be incorporated here as a solid substance or as a solution—dissolved in a suitable solvent—or as a so-called batch—mixed uniformly with a small amount of (A) or (A) with (F).

A two-component composition (2K) is likewise produced by uniform mixing of the individual compounds with the proviso that neither the A component nor the B component comprises at the same time compounds having aliphatic multiple bonds, compounds having Si-bonded hydrogen and catalyst, i.e. essentially not the constituents (A), (B) and (D) or (C) and (D) at the same time.

However, the silicone compositions according to the invention are preferably 1K silicone compositions.

The compounds (A) to (G) used in accordance with the invention can be in each case a single type of such a compound as well as a mixture of at least two different types of such a compound.

The crosslinkable silicone compositions according to the invention can be crosslinked by addition of Si-bonded hydrogen to aliphatic multiple bonds under the same conditions as the currently known compositions crosslinkable by the hydrosilylation reaction.

In this case, preference is given to temperatures of 10° C. to 220° C., more preferably 25° C. to 150° C., and a pressure of 900 to 1100 hPa. However, higher or lower temperatures and pressures can also be applied.

The silicone compositions according to the invention and the crosslinking products produced therefrom in accordance with the invention may be used for all purposes for which organopolysiloxane compositions crosslinkable to elastomers or elastomers are useful. The present invention therefore further relates to moldings or coatings produced by crosslinking the compositions according to the invention.

This includes, for example, the silicone coating or impregnation of any substrates, the production of molded parts, for example by the injection molding process, vacuum extrusion process, extrusion process, casting and compression molding, and impressions for use as sealing, embedding and casting compositions and so forth.

The crosslinkable silicone compositions according to the invention have the advantage that they can be produced in a simple process using readily accessible starting materials and thus economically. The crosslinkable compositions according to the invention have the further advantage that they have good storage stability as a one-component formulation at 25° C. and ambient pressure and only rapidly crosslink at elevated temperature. The silicone compositions according to the invention have the advantage that, in the case of a two-component formulation, these give rise to a crosslinkable silicone composition after mixing the two components, the processability of which remains unchanged over a long period at 25° C. and ambient pressure, i.e. exhibit extremely long pot life, and only rapidly crosslink at elevated temperature.

In the production of the crosslinkable silicone compositions according to the invention it is of major advantage that the noble metal catalyst (D) can be easily metered in and readily incorporated.

The silicone compositions according to the invention have the further advantage that the crosslinkable silicone rubbers obtained therefrom have excellent translucency/transparency.

The silicone compositions according to the invention further have the advantage that the hydrosilylation reaction does not slow down with reaction time.

### EXAMPLES

In the examples described below, all figures on proportion and percentages, unless stated otherwise, refer to weight. Unless otherwise stated, the following examples are carried out at a pressure of the surrounding atmosphere, i.e. at approximately 1000 hPa, and at room temperature, i.e. at approximately 20° C., or at a temperature which is set on mixing the reactants at room temperature without additional heating or cooling. In the following, all viscosity data refer to a temperature of 25° C. The following examples elucidate the invention without being limited thereto. The figures for the pot life refer to a doubling of the dynamic starting viscosity measured after 3 minutes' stirring of the sample with the aid of a paddle stirrer at a shear rate of 25 s⁻¹. The figures for the gelling time after exposure or at a particular temperature signify a doubling of the dynamic starting viscosity measured at a shear rate of 0.5 s⁻¹.

The following abbreviations are used:

Cat. Catalyst

Ex. Example

No. Number

BM Base mixture

Conc. Concentration

ppm parts per million

*) comparative example

In the examples various silicone compositions are used as base mixtures (BM) for the production of 1K silicone compositions. The ingredients are specified in Table 1.

TABLE 1

| | BM 1 | BM 2 | BM 3 | BM 4 | BM 5 | BM 6 | BM 7 | BM 8 | BM 9 |
|---|---|---|---|---|---|---|---|---|---|
| Compound A (Si—Vi) | x | x | x | x | x | x | x | x | x |
| Compound B (Si—H) | x | x | x | x | x | x | x | x | x |
| Compound C (Si—Vi, | | | | | | x | x | | |
| Si—H) | | | | | | | | | |
| Compound F1 | | | x | x | | x | | x | |
| Compound F2 | | | | | x | | x | x | x |
| Compound G | | | x | x | x | x | x | x | |
| SiH/Si—Vi | 1.8 | 0.7 | 2.0 | 0.7 | 2 | 1.6 | 1.6 | 1.8 | 2.0 |

Compound A: Compound A is an α,ω-divinyl-terminated linear polydimethylsiloxane with an average chain length of 220.

Compound B: Compound B is a linear comb crosslinker with an average chain length of 100 units and an S—H concentration of 1.7 mmol/g.

Compound C: Compound C is an α,ω-divinyl-terminated linear polydimethylsiloxane with an average chain length of 220, in which two chain units have on average one Si—H function.

Compound D: This is only later combined and varied with the different BM according to Table 2.

Compound F1: Fumed hydrophobic silica 130 m²/g

Compound F2: Fumed hydrophobic silica 300 m²/g

Compound G: (adhesion promoter, rheology additive): As compound G by way of example, (3-glycidyloxypropyl)trimethoxysilane is used.

The ratios by amount are adjusted as follows:

BM 1: 88% by weight compound A and 12% by weight compound B

BM 2: 95% by weight compound A and 5% by weight compound B

BM 3: 59% by weight compound A, 9% by weight compound B, 30% by weight compound F1 and 2% by weight compound G

BM 4: 64.5% by weight compound A, 3.5% by weight compound B, 30% by weight compound F1 and 2% by weight compound G

BM 5: 59% by weight compound A, 9% by weight compound B, 30% by weight compound F2 and 2% by weight compound G

BM 6: 30% by weight compound A, 3.5% by weight compound B, 34.5% by weight compound C, 30% by weight compound F1 and 2% by weight compound G

BM 7: 30% by weight compound A, 3.5% by weight compound B, 34.5% by weight compound C, 30% by weight compound F2 and 2% by weight compound G

BM 8: 60% by weight compound A, 8% by weight compound B, 15% by weight compound F1, 15% by weight compound F2 and 2% by weight compound G

BM 9: 59% by weight compound A, 9% by weight compound B and 30% by weight compound F1

For producing stable one-component silicone compositions, at least one noble metal catalyst is added. This is treated before use as follows (=compound D).

### Example 1: Preparation of a Stable Catalyst Cat.1

In a flask, 5 g of bis(σ-tert-butylethynyl)cyclooctadiene Pt(II) are dissolved in 50 ml of ethyl acetate. Following addition of 500 mg of 2,2′-bipyridine, the solution is stirred at room temperature for 24 hours. The solvent is then removed at room temperature by applying a vacuum.

### Example 2: Preparation of a Stable Catalyst Cat.2

In a flask, 5 g of bis(σ-tert-butylphenyl)cyclooctadiene Pt(II) are dissolved in 50 ml of ethyl acetate. Following addition of 50 mg of 1,10-phenanthroline, the solution is stirred at room temperature for 24 hours. The solvent is then removed at room temperature by applying a vacuum.

### Example 3: Preparation of a Stable Catalyst Cat.3

In a flask, 5 g of trimethyl[(allyldimethylsilyl)cyclopentadienyl]platinum(IV) are initially charged and 200 mg of neocuproine are added. The suspension is then stirred at room temperature for 24 hours.

### Example 4: Preparation of a Stable Catalyst Cat.4

In a flask, 5 g of trimethyl[(trimethoxysilyl)propyl(allyldimethylsilyl)cyclopentadienyl]platinum(IV) are initially charged and 1000 mg of poly-4-vinylpyridine are added. The suspension is then stirred at room temperature for 24 hours. The poly-4-vinylpyridine is completely removed by filtration by a glass frit with a pore size of 10-16 μm (G4).

### Example 5: Preparation of a Stable Catalyst Cat.5

In a flask, 5 g of trimethyl[(trimethoxysilyl)methyl(allyldimethylsilyl)cyclopentadienyl]platinum(IV), in which the methoxy groups have been replaced by OH-terminated polydimethylsiloxane polymers having a chain length of 600 to an extent of at least 70% in a pre-reaction, are initially charged, and 500 mg of 1,10-phenanthroline are added. The suspension is stirred at room temperature for 24 hours.

### Example 6: Preparation of a Stable Catalyst Cat.6

In a flask, 5 g of trimethyl[(trimethoxysilyl)methyl(allyldimethylsilyl)cyclopentadienyl]platinum(IV), in which the methoxy groups have been replaced by OH-terminated polydimethylsiloxane polymers having a chain length of 600 to an extent of at least 70% in a pre-reaction, are initially charged and 5 g of silica gel 60 (0.063-0.200 mm, CAS 7631-86-9), in which 5 weight percent of 1,10-phenanthroline have been bound covalently to the surface in a pre-reaction, are added. The suspension is stirred at room temperature for 24 hours. The silica gel coated with 1,10-phenanthroline is completely removed by filtration by a glass frit with a pore size of 10-16 μm (G4).

### Example 7: Preparation of a Stable Catalyst Cat.7

In a flask, 5 g of trimethyl[(3-dimethoxymethylsilyl)propyl(tert-butyl) cyclopentadienyl]platinum(IV), in which the methoxy groups have been replaced by OH-terminated polydimethylsiloxane polymers having a chain length of 200 to an extent of at least 70% in a pre-reaction, are initially charged and 500 mg of neocuproine are added. The suspension is stirred at room temperature for 24 hours.

### Example 8: Preparation of a Stable Catalyst Cat.8

In a flask, 5 g of trimethyl[(3-dimethoxymethylsilyl)propylcyclopentadienyl]platinum(IV), in which the methoxy groups have been replaced by OH-terminated polydimethylsiloxane polymers having a chain length of 600 to an extent of at least 70% in a pre-reaction, are initially charged, and 300 mg of dimercaprol are added. The mixture is stirred at room temperature for 24 hours.

### Example 9: Preparation of a Stable Catalyst Cat.9

In a flask, 5 g of bis(acetylacetonato)Pt(II) are dissolved in 50 ml of ethyl acetate and 5 g of silica gel 60 (0.063-0.200 mm, CAS 7631-86-9), in which 5 weight percent 2,2′-bipyridine have been bound covalently to the surface in a pre-reaction, are added. After stirring at room temperature for 24 hours, the coated silica gel is completely removed by a glass frit with a pore size of 10-16 μm (G4).

### Example 10: Cat.10

Bis(σ-tert-butylethynyl)cyclooctadiene Pt(II)

### Example 11: Cat.11

Bis(σ-tert-butylphenyl)cyclooctadiene Pt(II)

### Example 12: Cat.12

Trimethyl[(allyldimethylsilyl)cyclopentadienyl]platinum(IV)

### Example 13: Cat.13

Trimethyl[(trimethoxysilyl)propyl(allyldimethylsilyl)cyclopentadienyl]platinum(IV)

### Example 14: Cat.14

Trimethyl[(trimethoxysilyl)methyl(allyldimethylsilyl)cyclopentadienyl]platinum(IV) is initially charged, in which the methoxy groups have been replaced by OH-terminated polydimethylsiloxane polymers having a chain length of 600 to an extent of at least 70% in a pre-reaction.

### Example 15: Cat.15

Trimethyl[(trimethoxysilyl)methyl(allyldimethylsilyl)cyclopentadienyl]platinum(IV), in which the methoxy groups have been replaced by OH-terminated polydimethylsiloxane polymers having a chain length of 600 to an extent of at least 70% in a pre-reaction.

### Example 16: Cat.16

Trimethyl[(3-dimethoxymethylsilyl)propyl(tert-butyl) cyclopentadienyl]platinum(IV), in which the methoxy groups have been replaced by OH-terminated polydimethylsiloxane polymers having a chain length of 200 to an extent of at least 70% in a pre-reaction.

### Example 17: Cat.17

Trimethyl[(3-dimethoxymethylsilyl)propylcyclopentadienyl]platinum(IV), in which the methoxy groups have been replaced by OH-terminated polydimethylsiloxane polymers having a chain length of 600 to an extent of at least 70% in a pre-reaction.

### Example 18: Cat.18

Bis(acetylacetonato)Pt(II)

### Example 19: 1,3-divinyl-1,1′,3,3′-tetramethyldisiloxane (Karstedt Catalyst)

Table 2 shows the combinations of base mixtures with catalysts from which the crosslinkable compositions were produced and the results of the storage tests. The concentration data of the platinum catalyst refers to the metal which is customary in the literature. Comparative examples (=“*)”) show the characteristics of the non-stabilized non-inventive compositions. In examples 37 to 45, the compounds specified were used in the catalyst, but the stabilizing chelate ligand was not provided to the catalyst but to the silicone formulation at the end of the compounding process (=“**)”) It is significant that it is important for the scavenger effect to be carried out at the stage of the platinum catalyst or in the mixture. In this case it is unimportant whether the stabilizing compound remains in the crosslinkable mixture or is removed therefrom again, for example by using solid-phase bound ligands which can be removed by filtration.

TABLE 2

| | | | | Pot life | Pot life |
|---|---|---|---|---|---|
| Example | | | Pt Conc. | 50° C. | 23° C. |
| No. | BM No. | Cat.No. | [ppm] | [Days] | [Days] |
| 20 | 1 | 1 | 10 | 29 | >250 |
| 21 | 1 | 2 | 10 | 28 | >250 |
| 22 | 1 | 3 | 30 | 38 | >250 |
| 23 | 1 | 4 | 30 | 31 | >250 |
| 24 | 1 | 5 | 30 | 47 | >250 |
| 25 | 1 | 6 | 30 | 42 | >250 |
| 26 | 1 | 7 | 30 | 50 | >250 |
| 27 | 1 | 8 | 30 | 45 | >250 |
| 28 | 1 | 9 | 30 | 18 | >250 |
| 29 *) | 1 | 10 | 10 | <3 | 5 |
| 30 *) | 1 | 11 | 10 | <3 | 6 |
| 31 *) | 1 | 12 | 30 | <3 | 4 |
| 32 *) | 1 | 13 | 30 | <3 | 4 |
| 33 *) | 1 | 14 | 30 | <3 | 4 |
| 34 *) | 1 | 15 | 30 | <3 | 3 |
| 35 *) | 1 | 16 | 30 | <3 | 4 |
| 36 *) | 1 | 17 | 30 | <3 | 3 |
| 37 *) | 1 | 18 | 30 | <3 | 4 |
| 38 | 1 | 10 **) | 10 | 25 | >250 |
| 39 | 1 | 11 **) | 10 | 25 | >250 |
| 40 | 1 | 12 **) | 30 | 35 | >250 |
| 41 | 1 | 13 **) | 30 | 28 | >250 |
| 42 | 1 | 14 **) | 30 | 40 | >250 |
| 43 | 1 | 15 **) | 30 | 40 | >250 |
| 44 | 1 | 16 **) | 30 | 44 | >250 |
| 45 | 1 | 17 **) | 30 | 42 | >250 |
| 46 | 1 | 18 **) | 30 | 14 | >250 |
| 47 | 2 | 1 | 8 | 35 | >250 |
| 48 | 2 | 2 | 8 | 32 | >250 |
| 49 | 2 | 3 | 30 | 36 | >250 |
| 50 | 2 | 4 | 30 | 32 | >250 |
| 51 | 2 | 5 | 30 | 45 | >250 |
| 52 | 2 | 6 | 30 | 43 | >250 |
| 53 | 2 | 7 | 30 | 53 | >250 |
| 54 | 2 | 8 | 30 | 50 | >250 |
| 55 | 2 | 9 | 30 | 21 | >250 |
| 56 | 3 | 1 | 10 | 24 | >250 |
| 57 | 3 | 2 | 10 | 22 | >250 |
| 58 | 3 | 3 | 30 | 31 | >250 |
| 59 | 3 | 4 | 30 | 28 | >250 |
| 60 | 3 | 5 | 30 | 44 | >250 |
| 61 | 3 | 6 | 30 | 42 | >250 |
| 62 | 3 | 7 | 30 | 48 | >250 |
| 63 | 3 | 8 | 30 | 48 | >250 |
| 64 | 3 | 9 | 30 | 16 | 180 |
| 65 | 4 | 1 | 10 | 23 | >250 |
| 66 | 4 | 2 | 10 | 24 | >250 |
| 67 | 4 | 3 | 30 | 30 | >250 |
| 68 | 4 | 4 | 30 | 29 | >250 |
| 69 | 4 | 5 | 30 | 43 | >250 |
| 70 | 4 | 6 | 30 | 43 | >250 |
| 71 | 4 | 7 | 30 | 47 | >250 |
| 72 | 4 | 8 | 30 | 46 | >250 |
| 73 | 4 | 9 | 30 | 15 | 200 |
| 74 | 5 | 1 | 10 | 27 | >250 |
| 75 | 5 | 2 | 10 | 26 | >250 |
| 76 | 5 | 3 | 30 | 29 | >250 |
| 77 | 5 | 4 | 30 | 31 | >250 |
| 78 | 5 | 5 | 30 | 42 | >250 |
| 79 | 5 | 6 | 30 | 44 | >250 |
| 80 | 5 | 7 | 30 | 48 | >250 |
| 81 | 5 | 8 | 30 | 45 | >250 |
| 82 | 5 | 9 | 30 | 15 | 200 |
| 83 | 6 | 1 | 10 | 27 | >250 |
| 84 | 6 | 2 | 10 | 25 | >250 |
| 85 | 6 | 3 | 30 | 28 | >250 |
| 86 | 6 | 4 | 30 | 41 | >250 |
| 87 | 6 | 5 | 30 | 40 | >250 |
| 88 | 6 | 6 | 30 | 43 | >250 |
| 89 | 6 | 7 | 30 | 50 | >250 |
| 90 | 6 | 8 | 30 | 51 | >250 |
| 91 | 6 | 9 | 30 | 15 | 190 |
| 92 | 7 | 1 | 10 | 26 | >250 |
| 93 | 7 | 2 | 10 | 26 | >250 |
| 94 | 7 | 3 | 30 | 27 | >250 |
| 95 | 7 | 4 | 30 | 39 | >250 |
| 96 | 7 | 5 | 30 | 38 | >250 |
| 97 | 7 | 6 | 30 | 42 | >250 |
| 98 | 7 | 7 | 30 | 53 | >250 |
| 99 | 7 | 8 | 30 | 52 | >250 |
| 100 | 7 | 9 | 30 | 15 | 190 |
| 101 | 8 | 1 | 10 | 28 | >250 |
| 102 | 8 | 2 | 10 | 26 | >250 |
| 103 | 8 | 3 | 30 | 28 | >250 |
| 104 | 8 | 4 | 30 | 43 | >250 |
| 105 | 8 | 5 | 30 | 42 | >250 |
| 106 | 8 | 6 | 30 | 41 | >250 |
| 107 | 8 | 7 | 30 | 49 | >250 |
| 108 | 8 | 8 | 30 | 53 | >250 |
| 109 | 8 | 9 | 30 | 15 | 200 |
| 110 | 9 | 1 | 10 | 36 | >250 |
| 111 | 9 | 2 | 10 | 34 | >250 |
| 112 | 9 | 3 | 30 | 36 | >250 |
| 113 | 9 | 4 | 30 | 53 | >250 |
| 114 | 9 | 5 | 30 | 52 | >250 |
| 115 | 9 | 6 | 30 | 52 | >250 |
| 116 | 9 | 7 | 30 | 53 | >250 |
| 117 | 9 | 8 | 30 | 53 | >250 |
| 118 | 9 | 9 | 30 | 25 | >250 |
| 119 | 1 | 19 | 10 | — | <1 |

Table 3 compares the activity of the stabilized mixtures with non-stabilized comparative examples *) using base mixture 1 by way of example. Surprisingly, it has been found that the type of bidentate ligands used results in no significant prolongation of the gelling time. The figures for the gelling time after exposure or at a particular temperature signifies a doubling of the dynamic starting viscosity measured at a shear rate of 0.5 s⁻¹. The crosslinking reaction is activated thermally in examples 118, 119, 127 and 128 by a temperature increase to 150° C., examples 120 to 126 and 129 to 135 are activated by a 10 s exposure in a UV cube from Hohnle at a distance from the light source such that the radiation intensity at the sample site is ca.70 mW/cm2. After irradiation, the sample is transferred to a rheometer from Anton Paar and the viscosity is determined. The time specification is measured from the end of the 10s irradiation period.

TABLE 3

| | | | | | Pot life |
|---|---|---|---|---|---|
| Example | | | Pt conc. | Gelling | 23° C. |
| No. | BM Nr. | Cat.No. | [ppm] | time [s] | [Days] |
| 119 *) | 1 | 10 | 10 | 35 | 5 |
| 120 *) | 1 | 11 | 10 | 36 | 6 |
| 121 *) | 1 | 12 | 30 | 20 | 4 |
| 122 *) | 1 | 13 | 30 | 20 | 4 |
| 123 *) | 1 | 14 | 30 | 22 | 4 |
| 124 *) | 1 | 15 | 30 | 23 | 3 |
| 125 *) | 1 | 16 | 30 | 20 | 4 |
| 126 *) | 1 | 17 | 30 | 20 | 3 |
| 127 *) | 1 | 18 | 30 | 70 | 4 |
| 128 | 1 | 1 | 10 | 34 | >250 |
| 129 | 1 | 2 | 10 | 36 | >250 |
| 130 | 1 | 3 | 30 | 22 | >250 |
| 131 | 1 | 4 | 30 | 23 | >250 |
| 132 | 1 | 5 | 30 | 21 | >250 |
| 133 | 1 | 6 | 30 | 22 | >250 |
| 134 | 1 | 7 | 30 | 23 | >250 |
| 135 | 1 | 8 | 30 | 45 | >250 |
| 136 | 1 | 9 | 30 | 73 | >250 |

1.-8. (canceled)

9. An addition-crosslinking silicone composition, comprising:
a) at least one compound of each of (A), (B), (D) and (E), or
b) at least one compound of each of (C), (D), and (E), or
c) at least one compound of each of (A), (B), (C), (D) and (E)
wherein
(A) is an organic compound or an organosilicon compound comprising at least two radicals having aliphatic carbon-carbon multiple bonds,
(B) is an organosilicon compound comprising at least two Si-bonded hydrogen atoms,
(C) is an organosilicon compound comprising SiC-bonded radicals having aliphatic carbon-carbon multiple bonds and Si-bonded hydrogen atoms,
(D) is a noble metal catalyst, wherein the noble metal is in an oxidation state greater than 0, and
(E) is an at least bidentate chelate ligand,
with the proviso that the compound (D) and (E) have been pre-mixed prior to incorporation with a), b), or c), or the compound (E) is mixed into the composition a), b), or c) uniformly with compound (D), wherein the compound (E) remains in the silicone composition.

10. An addition-crosslinking silicone composition, comprising:
a) at least one compound of each of (A), (B), (D) and (E),
b) at least one compound of each of (C), (D) and (E) and
c) at least one compound of each of (A), (B), (C), (D) and (E)
wherein
(A) is an organic compound or an organosilicon compound comprising at least two radicals having aliphatic carbon-carbon multiple bonds,
(B) is an organosilicon compound comprising at least two Si-bonded hydrogen atoms,
(C) is an organosilicon compound comprising SiC-bonded radicals having aliphatic carbon-carbon multiple bonds and Si-bonded hydrogen atoms,
(D) is a noble metal catalyst, wherein the noble metal is in an oxidation state of greater than 0, and
(E) is an at least bidentate chelate ligand,
with the proviso that the compound (D) and (E) have been pre-mixed prior to incorporation into a), b), or c), and
with the proviso that the compound (E), after treatment and prior to mixing with the other compounds, has been removed.

11. The addition-crosslinking silicone composition of claim 9, wherein (D) is a Pt or Pd catalyst and Pt and Pd are in the +II or +IV oxidation states.

12. The addition-crosslinking silicone composition of claim 10, wherein (D) is a Pt or Pd catalyst and Pt and Pd are in the +II or +IV oxidation states.

13. The addition-crosslinking silicone composition of claim 9, wherein (D) is an Ir or Rh catalyst and Ir and Rh are in the +I or +III oxidation states.

14. The addition-crosslinking silicone composition of claim 10, wherein (D) is an Ir or Rh catalyst and Ir and Rh are in the +I or +III oxidation states.

15. The addition-crosslinking silicone composition of claim 9, wherein the molar ratio of the compound (E) to the compound (D) is between 0.0001 and 10.

16. The addition-crosslinking silicone composition of claim 10, wherein the molar ratio of the compound (E) to the compound (D) is between 0.0001 and 10.

17. The addition-crosslinking silicone composition of claim 11, wherein the molar ratio of the compound (F) to the compound (D) is between 0.0001 and 10.

18. The addition-crosslinking silicone composition of claim 13, wherein the molar ratio of the compound (E) to the compound (D) is between 0.0001 and 10.

19. A method for the preparation of an addition-crosslinking silicone composition of claim 9, comprising uniformly mixing the individual compounds to give a one-component composition (1K).

20. A method for the preparation of an addition-crosslinking silicone composition of claim 10, comprising uniformly mixing the individual compounds to give a one-component composition (1K).

21. A method for preparation of an addition-crosslinking silicone composition of claim 9, comprising uniformly mixing individual components to give a two-component composition (2K), with the proviso that neither the A component nor the B component comprises compounds at the same time having aliphatic multiple bonds, compounds having Si-bonded hydrogen and catalyst.

22. A method for preparation of an addition-crosslinking silicone composition of claim 10, comprising uniformly mixing individual components to give a two-component composition (2K), with the proviso that neither the A component nor the B component comprises compounds at the same time having aliphatic multiple bonds, compounds having Si-bonded hydrogen and catalyst.

23. A molding or coating produced by crosslinking an addition-crosslinking silicone compositions of claim 9.

24. A molding or coating produced by crosslinking an addition-crosslinking silicone compositions of claim 10.
